(19) United States
(12) Patent Application Publication
(10) Pub. No.: US 2012/0320416 A1
(43) Pub. Date: Dec. 20, 2012

(54) HIGHLIGHTING IN WEB BASED READING SYSTEM AND METHOD

(75) Inventors: Ernest V. Mbenkum, Toronto (CA); Mark Hempel, Edina, MN (US)

(73) Assignee: SUMBOLA, INC., Toronto (CA)

(21) Appl. No.: 13/474,024

(22) Filed: May 17, 2012

Related U.S. Application Data
(63) Continuation-in-part of application No. 13/163,795, filed on Jun. 20, 2011.
Application No. 13/163,795 is a continuation-in-part of application No. 13/163,797, filed on Jun. 20, 2011.
(60) Provisional application No. 61/622,778, filed on Apr. 11, 2012.

(51) Int. Cl. G06F 17/00; G06K 15/02; G06F 15/16

(52) U.S. Cl. 358/1.15; 715/254; 707/769; 707/723; 707/748; 707/752; 707/E17.014; 707/E17.008

(57) ABSTRACT

A system and method is presented for the highlighting of web-based books and text documents. Data is maintained in a database relating to books, chapters, pages, and page portions. Through the use of a user interface, users create highlights to the text documents by adding highlight database items to the database associated with page portions. Highlighted text portions are used to create excerpt documents, to value and price a request to license a portion of a text document, and to perform searches relating to the text document.

### RELATED APPLICATIONS

The present application is a continuation-in-part of U.S. patent application Ser. No. 13/163,795, filed Jun. 20, 2011, and also a continuation-in-part of U.S. patent application Ser. No. 13/163,797, also filed on Jun. 20, 2011, each of which are hereby incorporated by reference. The present application also claims the benefit of U.S. Provisional Application No. 61/622,778, filed on Apr. 11, 2012.

### FIELD OF THE INVENTION

The present application relates to the field of document review. More particularly, the described embodiments relate to a system and method for allowing a user of a web based reading system to highlight text, to store highlights separately for multiple users or multiple documents, and for utilizing highlighting by users to value portions of text document more highly that other portions.

### BRIEF DESCRIPTION OF THE DRAWINGS

FIG. 1 is a block diagram showing a computerized system in used by a plurality of users, authors, and publishers.

FIG. 2 is a block diagram showing a server computer operating a web server to present interfaces over the World Wide Web.

FIG. 3 is a block diagram showing user related database elements.

FIG. 4 is a diagram showing a reading and highlighting interface for one embodiment of the present invention.

FIG. 5 is a flow chart showing a method for highlighting a document.

FIG. 6 is a diagram showing an excerpt document created through the interface of FIG. 4.

FIG. 7 is a flow chart showing a method for creating an excerpt document.

FIG. 8 is a diagram showing a licensing interface for one embodiment of the present invention.

FIG. 9 is a flow chart showing a method for licensing portions of a highlighted document.

FIG. 10 is a flow chart showing a method for searching highlighted portions of a document.

### DETAILED DESCRIPTION

### Overview

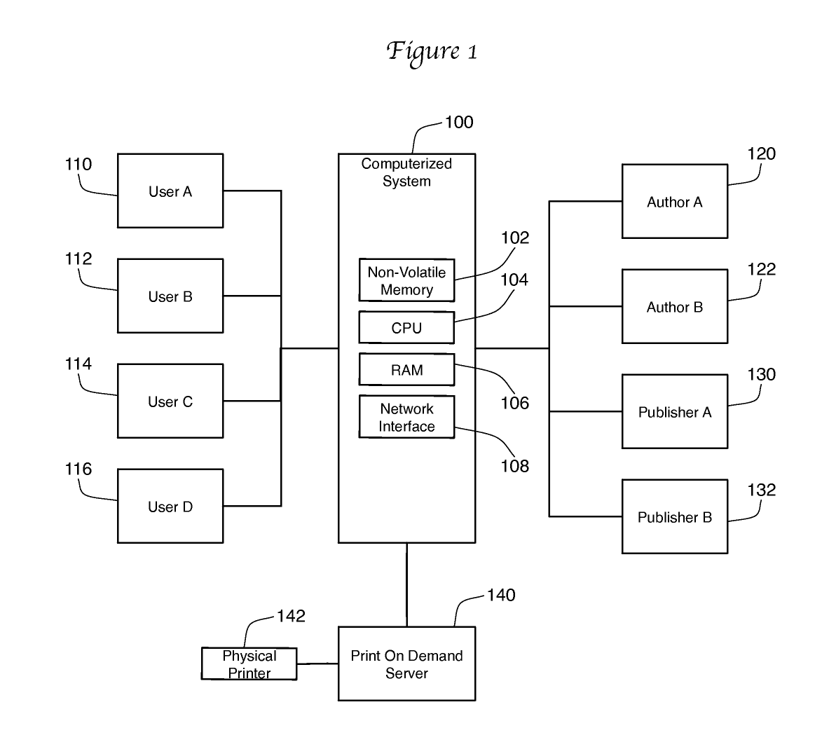

FIG. 1 is a block diagram showing a plurality of users 110-116, authors 120-122, and publishers 130-32 that are connected to a computerized system 100. The computerized system 100 provides an interactive interface to users 110-116 that allows users to page through and read one or more books. In the present description, users 110-116 are those individuals who use the computerized system 100 to read a book, to review information and content about the book, to highlight and license portions of a book, and to interact with other parties concerning that book. Authors 120-122 are those individuals who authored the books that are available for reading on the system 100. Publishers 130-132 are the entities that publish the printed version of the books, or entities that otherwise assist in the publicity for or distribution of the books.

In this description, the term author, publisher, and book are used to describe an embodiment of the present invention. However, it is not necessary that the material being read by a user constitute a book per se. For instance, the content may be a journal article, a news report, etc. The authors using the system would not then be book authors, but could be an article writer, poet, journalist, or any other type of content creator. The publisher also need not be a written book publisher, but could be any entity that works on publicity or distribution of the written content. Consequently, the word book should be construed broadly to mean written content, the word author should be construed to mean the creator of the written content, and the word publisher should be construed to mean an entity involved in publicity or distribution of the written content.

The computerized system 100 includes a set of software instructions or interfaces stored on a non-volatile, non-transitory, computer readable medium 102 such as a hard drive or flash memory device. A digital processor 104, such as a general purpose CPU manufactured by Intel Corporation (Mountain View, Calif.) or Advanced Micro Devices, Inc. (Sunnyvale, Calif.) accesses and performs the software. To improve efficiency, processor 104 may load software stored in memory 102 into faster, but volatile RAM 106. Data operated upon by the software can also be stored in non-volatile memory 102 and retrieved into RAM 106 for analysis, recording, and reporting. The computer system 100 further includes a network interface 108 to communicate with other computerized devices across a digital data network. In one embodiment, the network is the Internet or an Intranet, and the network interface 108 includes TCP/IP protocol stacks for communicating over the network. The network interface 108 may connect to the network wirelessly or through a physical wired connection. Instead of being a single computer with a single processor 104, the computerized system 100 could also implemented using a network of computers all operating according to the instructions of the software.

By using the computerized system 100, users 110-116 not only receive access to the book that they wish to read, but they also participate on a social community related to that book. These social communities include content created by, and interaction between other users 110-116 who are also reading the book, the author or authors 120-122 of the book, and other entities such as publishers 130-132 who are publicizing and attempting to generate interest in the book. This content can include notes about a particular page, chapter, or section of the book created by the users 110-116.

In addition, this content can include user created highlights for the book. For example, while reading the book, user A 110 may wish to highlight numerous portions of the book in order to emphasize the importance of those portions. By using the computerized system 100, user A 110 may keep those highlighted portions private, for their own personal later use, or can share the highlighted portions with other users of the system 100. Assuming that the highlight has been made public, user B 112 may choose to reveal the highlights made by user A 110 when reading that book. User C 114 may read the same page and then create a separate collection of highlighted portions for their own personal use or for sharing with others.

Author A 120 may request statistics concerning user interaction with the book. The computerized system 100 can respond by informing the author 120 of the total number of users who have purchased access to the book, the number of active readers, the number of notes and highlighted passages made by readers of the book, and other statistics related to the book. In addition, by tracking user interaction with the particular portions of the book, the computerized system 100 can provide author A 120 with valuable insights into the way users perceive different parts of the book. For instance, the computerized system 100 can indicate which portions contain the highest concentration of highlights, and which pages contain the greatest number of notes and the greatest amount of interaction between users 110-116. By tracking the time spent on particular pages, the computerized system 100 can also inform the author 120 which pages users read quickly, and which pages users read slowly. In fact, by tracking pages read over time, the computerized system can determine whether a user has effectively abandoned the reading of a particular book, and the page where the user stopped reading the book (the user's “defection point”). Similar statistics can be made available to publishers 130-132 about their books, allowing both authors 120-122 and publishers 130-132 to obtain valuable feedback on the particular strengths and weaknesses of various books based on actual monitoring of user reading habits.

In addition to tracking statistics, the computerized system 100 can utilize its knowledge about user highlights to generate extracts from the book. User A 110, for instance may wish to review only the portions of the book that were highlighted by user A 110. The computerized system could display these portions directly to the user over a computerized interface. Alternatively, user A 110 could request that the computerized system 100 print those portions in a printed document. This printing could occur through a print-on-demand service provided through a computerized server 140 accessible over a wide area network. Upon receiving the request from user A 110, the computerized system 100 would submit a request for a printed publication from the print-on-demand server 140. The computerized system 100 would transmit those portions of the book that have been highlighted by the user A 110 to the print-on-demand server 140, which would then print this material on a physical printer 142. The printed document would then be delivered through standard fulfillment means, such a government postal service, to user A 110.

Rather than restricting the extract of the book to portions highlighted by user A 110, the computerized system 100 could also give user A 110 the ability to create extracts based on the portions highlighted by other users (such as users 112, 114, and 116). This would allow user A 110 to view or print an extract of the book that is limited to those portions that have been valued by other users through the highlighting tool of the computerized system 100. Through an interface tool, user A 110 can request that the extract include all portions highlighted by any users, or restrict the extract to those portions highlighted by more than one person (such as 2, 3, or some other number of other persons). By limiting the extract to portions highlighted by four or more users, for example, user A 110 could limit the size of the extract while also being assured that the extract will include those portions that have been considered important by at least four other users. These extracts could include only the actual highlighted text, or could include additional text surrounding the highlights in order to put the highlighted portions in context.

### Implementation as a Web Server

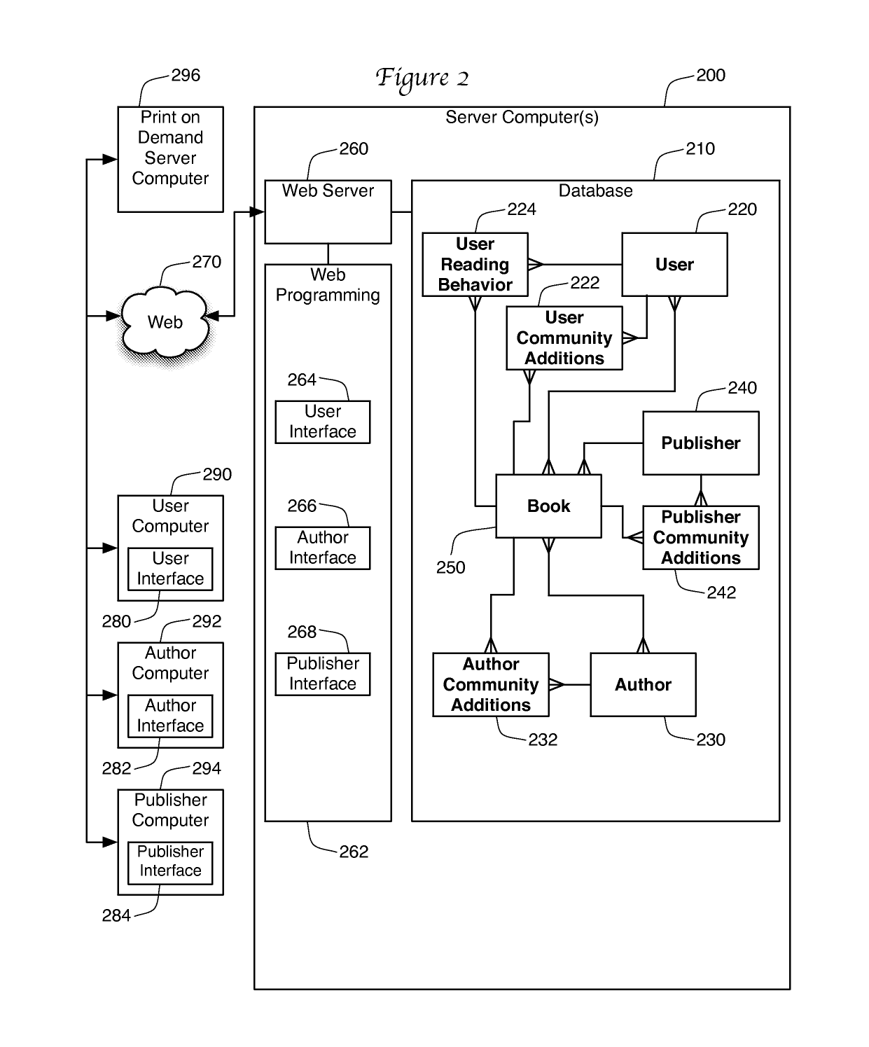

The computerized system 100 of FIG. 1 can be implemented as one or more web server computers 200 as shown in FIG. 2. The computerized system 200 is capable of storing information about all of the parties that use the system 200. In the preferred embodiment, the server computer 200 stores this information in a database 210. This information can be maintained as separate tables in a relational database, or as database objects in an object-oriented database environment within the database 110. FIG. 2 shows the database 210 with tables or objects for users 220, authors 230, publishers 240, and books 250. This allows the database 210 to maintain information about the users 110-116, authors 120-122, and publishers 130-132 that may access the server computer 200. Of course, the table or object entities shown in FIG. 2 should not be considered to show actual implementation details of the database 210, since it is well within the scope of the art to implement this type of data using a variety of entity architectures. The entities shown are exemplary, intended to aid in the understanding of the data maintained by the system database 210 in this embodiment. For example, it would be well within the scope of the present invention to divide information about users 220 into multiple tables or objects, instead of the single user entity 220 shown in FIG. 2. Similarly, it would be possible to implement the database 210 such that information about users, authors, and publishers all use a single database table or object, where the role (user, author, publisher) for each instance is defined using a field within that table or object. Finally, it is not even necessary to implement these entities as formal tables or objects, as other database paradigms could also effectively implement these types of data structures.

Relationships between these entities 220-250 as well as the other entities in the database 210 are represented in FIG. 2 using crow's foot notation. For example, FIG. 2 shows that a book 250 may have multiple authors 230, but only a single publisher 240. Each author 230 and publisher 240 can, in turn, have multiple books 250. Users 220 in the database 210 can be associated with multiple books 250, and each book 250 can itself be associated with multiple users 220. “Associations” (or “relationships”) between database entities 220-250 can be implemented through a variety of known database techniques, such as through the use of foreign key fields and associative tables in a relational database model.

The database also tracks the contributions made to the community surrounding a book 250 by each of the various participants. For instance, each user 220 can make multiple user community additions 222 to the system 200. These additions 222 may include highlights, page notes, chapter comments, book reviews and ratings, chat room contributions, etc. While each user 220 may make user community additions 222 about any book 250 with which they are associated in the database 210, each user community addition 222 is related to only one particular book 250. Similarly, each author 230 may make author community additions 232 to the database 210, thereby allowing the author 230 to make comments, updates, and blog posts about one of their books 250. The various community additions 222, 232, 242 that are associated with a book 250 together constitute the social community oriented around that book 250.

Users of the system 200 are given access to a book's content by associating their user record 220 with the appropriate book record 250 in the database. The text of the book is stored in the book record 250 or in related database records. Users whose record 220 is associated with the book 250 are granted access to the books' related community additions 222, 232, 242.

User interaction with the book's content through the sever computer 200 are stored in user reading behavior records 224. These records can indicate when a user purchased a book, or started reading that book. Additional records can track each page turn (or “page clicks”) by the user. Only by tracking user interaction with a book at the page level can some of the most useful information about the book and the user be generated.

The database 210 is used by a web server 260 operating on one or more of the server computers 200 to generate the various interfaces used by the system 10. In particular, web programming 262 exists that defines how to create a user interface 264, an author interface 266, and a publisher interface 268 using the data in the database 210. This programming 262 allows the web server 260 to transmit over the World Wide Web 270 (or an intranet) a user interface 280 that can be seen by a browser operating on a computer 290 for the benefit of a user. Similarly, the web server 260 can manage an author interface 282 on browser operating on an author computer 292, and a publisher interface 284 operating on a publisher computer 294. Each computer 290, 292, 294 could be a standard personal computer operating a Microsoft Windows, Linux, or Apple Mac OS operating system. Alternatively, these computers 290-294 could be mobile devices, such as smart phones or tablet computers, operating Google Android, Apple iOS, or Microsoft Windows Phone operation system. In addition, the device could be a “smart” or Internet enabled television.

The server computer 200 is also able to communicate with a print-on-demand server computer 296 over a network connection, such as via network 270. This allows the server computer 200 to request that the print-on-demand server computer 296 print a particular document and then ship that document to one of the user's of the server computer 200.

### User Related Data

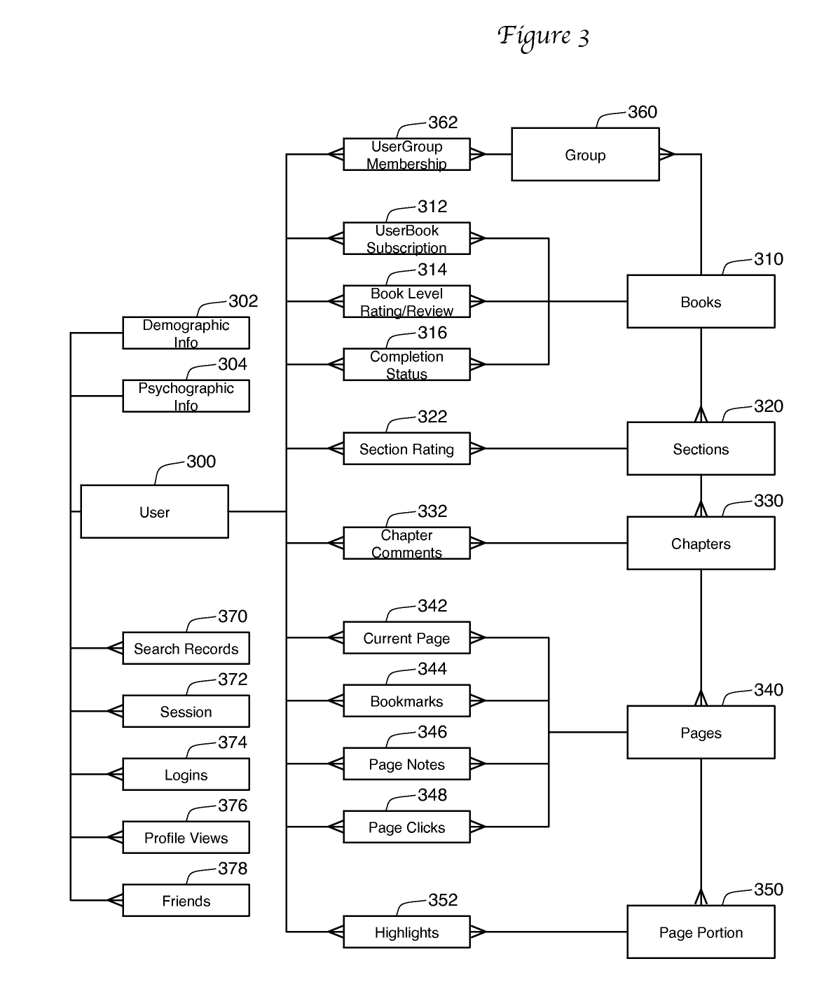

FIG. 3 shows the database elements 300-378 used by the database 210 to track information about users and their interactions with books. The user database element 300 is connected to the book element 310 primarily by the UserBook subscription 312. This element 312 indicates that the user 300 has purchased or otherwise obtained access to the book 310. Relationships between entities in FIG. 3 can be established using any of the standard techniques known in the field of database design. In the present case, a unique user ID is assigned to each user entry 300, and a unique book ID is assigned to each book entry 310. All other entities that relate to the user 300 or book 310 make that relationship using the user ID or book ID, respectively, either as a direct foreign key entry into the related record or through the use of associative tables.

User information, such as the user's name, address, username, password, etc. is stored in the user database element 300. Related records can also be created to store similar information. For instance, the database elements in FIG. 3 separate demographic info 302 (such as age, sex, geographic location, and income) and psychographic info 304 (such as reading preferences and past purchasing behavior) into separate elements from the user 300, even though it would be a simple matter to integrate this same information into the definition of a user table or object 300. The book element 310 itself contains information about the book (such as the book's title, date of copyright, ISBN number, etc.), although such data could also be located in separately defined database elements.

In the preferred embodiment, users 300 who have finished reading a book 310 are permitted to create a book rating and review 314 for the book 310. Users 300 who have not completed the book 310 may leave comments about parts of a book, but may not created a book level rating or review 314. The completion status detailing a user's interaction with a book is stored in database element 316.

In the embodiment shown in FIG. 3, books 310 are conceptually subdivided into sections 320. Sections 320, in turn, are subdivided into chapters 330, which are made up of pages 340. Each of these subdivisions is represented by separate database elements. In the preferred embodiment, the actual content or text of the book 410 is stored in the page level database element 440. Pages 340 themselves contain words. In the present embodiment, it is possible to highlight some words on a page and not other words. In order to track data on a word level, the database 210 contains a page portion subdivision 350. These portions 350 identify one or more words in a particular page. In one embodiment, the page portion database element identifies word ranges on a page by specifying an index range for the desired words on the page. For instance, a sentence on a book page that ran from the 34^{th} word on the page to the 52^{nd} word would be identified by the portions database construct 350 by storing these numeric indexes, with the page containing these words being identified by a link in the database 210 to the correct page database entity 340. By defining page portions 350 in this manner, new page portions 350 can be created whenever desired by a user. Assuming that page portions 350 are used only when a user elects to highlight words on a page, some pages 340 with no highlights would have not associated page portions 350, while other pages 340 with many highlights would have numerous page portions 350 defined. It is to be expected that page portions 350 will include overlapping page ranges as necessary to implement the highlighting of various users.

One of the primary advantages of these subdivisions 320-350 is that user community additions relating to this book can be associated with the particular subdivision. For instance, users 300 are allowed to create separate section ratings 322 for each section 320, create chapter comments 332 for each chapter 330, create bookmarks 344 and page notes 346 for each page, and to create highlights 352 for page portions 350.

On the page 340 level, the database tracks the current page 342 being reviewed by the user. By separately storing this information, the system allows a user to quickly return to their place within a book at later time, even after a significant delay between reading sessions. Multiple pages in a book 310 that are of particular interest to a user can be marked using bookmarks 344. The page level notes data structure 346 can contain a note left by the user, as well as the user's preferences about the note. For instance, the user can designate that the note is a private note that should be viewed only by the user, or designate that the note is public, thereby allowing the system 100 to share the note with all readers reaching that same page 340 of the book 310. Such private and public settings can also apply to individual highlights 352. In the preferred embodiment, public notes 346 and highlights 352 are accessible to all users 300 of the book 310, thereby allowing communication between otherwise unrelated users 300. In one embodiment, page notes 346 can relate to other notes 346, thereby allowing the creation of threaded, back-and-forth discussions within the book's community.

In another embodiment, the user can participate in a book's community as part of a group 360. A group 360 is a subset of all users that are reading a particular book 310. In this embodiment, a third option of sharing page notes 346 and highlights 352 can be presented, where notes can be viewed by members of the group 360 but not by other readers of the book 310. The membership of a user 300 in a group 360 is defined by the UserGroup membership database entity 362.

Another advance made by the present invention relates to the ability to track page clicks 348. Page click entries 348 detail when a user 300 requests access to a particular page 340 of a book 310. An analysis of page click records 348 can determine whether a user 300 has completed reading a book 310, which could then be recorded in the completion status record 316. Similarly, one embodiment of the present invention may record all search requests 370 made by a user 300. Search requests may relate to a particular book 310, or may be made over multiple books 310.

In addition to page clicks 348 and search records 370, it may be useful to record user interaction with page notes 346 or highlights 352. For instance, each time a user requests to view the highlights 352 (or page notes 346, chapter comments 332, or book review 314) of another user, the database 210 could track this viewing. This would help the system identify the users whose contribution to the community were most valued by other users. For example, in one embodiment, users are ranked based upon their total value to the community. Various scores are created for the users based on at least one of the following criteria: percentage of pages read for which the user created a note, percentage of chapters finished for which the user has created a chapter comment, percentage of books completed for which the user has submitted a book level review or responded to a book-related survey, number of highlights created, other user's ratings of the user-created notes and comments, frequency of use of the user's highlights by other users, total logins in a given time period, and purchases made by the user within the system. The various scores can be weighted to create a total contribution score, which can then be compared to other users in order to value the overall contributions of that user.

Other types of user related data can also be maintained in the database, including a record of user sessions 372 and logins 374. Sessions 372 are used to keep track of a user's online status. Logins 374 track in the database 210 how often a user has logged into the site, and when they last logged in.

The system also maintains records of user interactions with other users, such as when one user views the profile of another user (profile views 376), or when one user befriends another (record 378). As seen in other social networking environments, the linking of users 300 with friends allows users 300 to explore the interests and activities of their individually selected friends.

### User Reading Interface

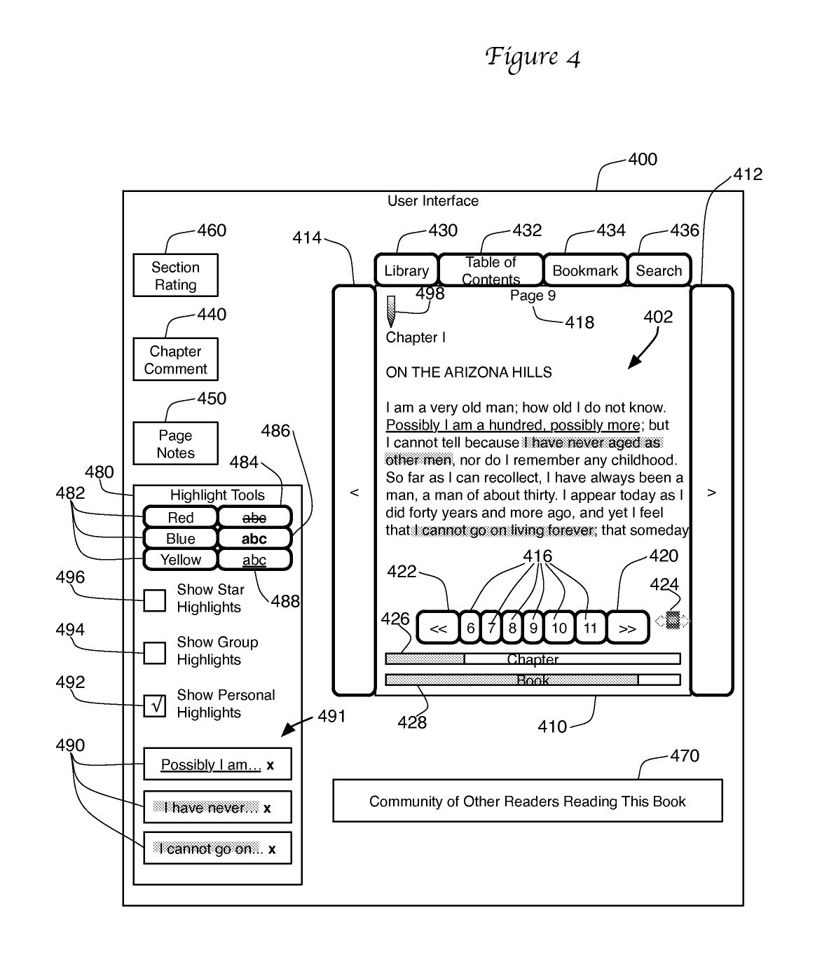

As explained above in connection with FIG. 2, a user will interact with the web-reading system of the present invention through a user interface 280 operating on a user computer 290. This user interface 280 is generated by the web server 260 operating on one or more server computers 200, and then transferred to the user computer 290 over the Internet 270, an intranet, or some other computerized network. FIG. 4 shows one embodiment of a user interface 400 that could be viewed by a user of the system of FIG. 2. This particular interface 400 is designed to allow a user to read a book that is stored in the database 210 accessed by the server computers 200. This database 210 may be constructed, in part, using the data entities shown in FIG. 3.

As the purpose of the reader user interface 400 is to allow the user to read a book, the current page being read (element 410) dominates the interface 400. In the preferred embodiment, books are read page-by-page. Consequently, the reading user interface 400 presents a single page 410 to the user. To move the page displayed 410 from one page to the next, the user simply presses the next page button 412, which is preferable found along the entire right side of the page window 410. Similarly, the previous page button 414 is found along the entire left side of the page window 410. It is also possible to go to a different page by pressing one of the page specific buttons 416 found at the bottom of the page 410 being read.

At the bottom of the page window 410 are two progress bars 426, 428. These bars 426, 428 indicate at a glance how far the user currently is in the current chapter (bar 426) and the entire book (bar 428). At the top of the page window 410 are several menu buttons 430-436. The first button 430 brings the user to the library interface, where the user can select a new book. The table of contents button 432 presents the table of contents for the current book in the current page window 410. The bookmark button creates a bookmark database entry 344 for the current user at that page. Finally, the search button 346 presents the user with a search interface.

One of the benefits of the present invention is for users to review chapter comments 440 and page notes 450 associated with the page 410 currently being read. The chapter comments 440 are taken from the chapter comments entity 332 in the database 210. The chapter comments window 440 and page notes window 450 allow the user to create new entries, see old entries created by that user or that are shared by other users, restrict the displayed entries to personal or group entries, rate the entries made by other users, or to search existing entries. The reading user interface 400 allows the user to give a rating to the section 320 relating to the current page through the section rating interface 460. Another benefit of the present invention is the ability to find and interact with other users who are reading the same book. The community of other readers window 470 lists other users who are currently reading the same book as shown in window 410.

Finally, the reading interface 400 includes highlight tools 480 that allow a user to highlight a portion of the text 402 shown on the page 410. The highlight tools 480 allow a user to select a particular type of highlight through the use of a color highlight button 482, a cross-through highlight button 484, a bold highlight button 486, or an underlined highlight button 488. The interface 400 shown in FIG. 4 includes three different color highlight buttons 482, allowing the user to choose between red, blue, and yellow highlights. Traditionally, the term highlight has been limited to placing a color or gray scale background behind text, while underlining and cross-through effects have been considered to be font-formatting changes. In the present disclosure, font changes (such as single or double underline, single or double cross-throughs, bold, font size, font family change, or italics) and background changes (color or gray scale) that may be made to text portions are both considered “highlights.” The user interface 400 can make any of these highlighting options available through the highlight tools 180, such as by having a plurality of buttons 482-488 with each button providing one type of highlighting, or by having color selection or font formatting tools that allow the user to select any desired background color or any desired font formatting change for the highlight.

Highlights made by the user are applied to a portion of the text 402 shown in the page view window 410. In FIG. 4, the text “Possibly I am a hundred, possibly more” has been highlighted with an underlined highlight, while the two text portions “I have never aged as other men” and “I cannot go on living forever;” have been highlighted with a color highlight. These portions can be defined through page portion database entity 350, with the highlights applied to those portions by creating the appropriate page portions entities 350 and highlight database entities 352 in the database 210. Obviously, it would be within the scope of the present invention to combine these two entities 350, 352 into a single database entity that defines the type of highlight and the portion of the page to which the highlight is defined. The highlighted portions on the current page are also displayed as entries 490 listed within a highlighted portions list 491 displayed in the highlight tool box 480. Each highlighted portion 490 listed in the tool box 480 displays the first few characters of the text portion 350 with desired the highlight being applied. In addition, each entry 490 in the highlight list 491 includes a removal icon (such as the “x” in FIG. 4). By clicking on the removal icon, the computerized system 100 will delete the associated database entries (352 and perhaps 350), remove that highlight from the displayed text 402 of the current page 410, and delete the entry 490 from the tool box 480.

In the preferred embodiment, the user can select check boxes 492-496 to select whether or not to display on page screen 410 personal highlights, group highlights, or “star” highlights. Personal highlights are those highlights created by the user currently view the page 410, and can be turned on and off through checkbox 492. Group highlights are those highlights created by other users that are within the same group 360 as the current user, and are switched between being displayed and being hidden through checkbox 494. If the user belongs to more than one group, the show group highlights selection checkbox 494 will also include the ability for the user to select which group or groups should be used to display the highlights. Star highlights are highlights made by other users including users not within any of the groups 360 of the current user, and are displayed and hidden through checkbox 496. Depending on the embodiment, star highlights will show any highlight made by any user to this page 410 of the current book. In other embodiments, only highlights created by highly ranked users will be displayed on the page 410. In still further embodiments, only those portions of the text 402 that have been highlighted by multiple users will be displayed. In some cases, only two users need to highlight that portion of the text 410 for the highlight to appear in the page view 410. In other cases, the minimum number of users required to highlight a word before the highlight appears may be higher, such as three, four or ten users. In one embodiment, only personal highlights retain the color or font attributes applied when the user originally added the highlight to the text 402 of a page 410. Group highlights and star highlights are made in a generic way, so that highlighting made a first user in red would appear on the page display 410 in the same manner as highlighting made by a second user in yellow and highlighting made by a third user using underlining or bolded text.

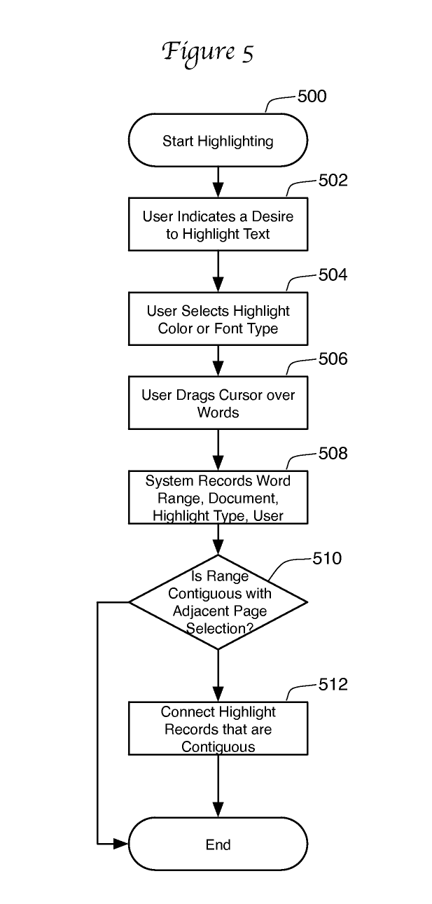

To add highlighting to the text 402 on a page 410, the process 500 shown in FIG. 5 is followed. First, at step 502, the user indicates a desire to highlight text. This can be accomplished by clicking on an icon 498 found on the interface 400. To stop the highlighting process, the user simply clicks again on the icon 498. In the preferred embodiment, the highlight tool box 480 appears (or expands in size) when the icon 498 is pressed to turn on highlighting for the first time. Note that in FIG. 4, the highlight tool box 480 takes up a large amount of the user interface 400 when compared with the chapter comment 440, page notes 450, section rating 460, and community of readers 470 elements. This indicates that the highlight tool box 480 is currently active, while also indicating that the user is not currently using the other interface elements 440-470. In other embodiments, all of these elements 440-480 could be of similar size that does not change when activated. In still further embodiments, these elements 440-480 could share real estate on the user interface 400 such as by using a tabbed-element interface, which allows a user to select between these elements by selecting on an appropriate tab on the interface 400.

At step 504, the user selects a color or font type for the highlighting by selecting one of the buttons 482-488. In some embodiments, a default highlighting technique is automatically selected if a user does not select a highlighting technique. At step 506, the user selects text 402 on the page using a cursor, such as by pressing a mouse button while dragging the cursor over the text 402. In the preferred embodiment, a word is the smallest unit that can be highlighted, and a selection of a single letter in the word automatically selects the entire word.

As the user drags the cursor over the text 402, the text portion being defined changes its appearance according to the highlighting selection button 482-488 selected by the user. When the user stops the selection process, the text portion is selected and information about the highlight is stored in the database 210, such as in database elements 350 and 352. It is important that these database elements uniquely identify the user 300 that made the highlight, the page portion 350 that is highlighted (including the page 340 and book 310 in which that page portion 350 is found), and the type of highlighting selected by the user through buttons 482-488. In one embodiment, the time at which the highlighting was made is also stored in the highlight database element 352.

In one embodiment, highlights cannot extend beyond a page. This is consistent with the page-oriented nature of the preferred embodiment. However, it can be useful to identify situations where contiguous text is highlighted across multiple pages. This situation is identified in element 510 by determining whether a highlight at the end of one page can be matched with the same highlighting type (i.e., color or font format) at the beginning of the next page, or whether highlighting at the beginning of one page can be matched with the same type of highlighting at the end of the previous page. If contiguous text is identified, then step 512 will associate these text elements together for use at a later time when retrieving or searching highlights. At this point, the highlighting method ends at step 514. If the highlighted text portion is not contiguous with other highlighted portions, as determined by step 510, then the method simply ends at step 514.

### Excerpt Documents

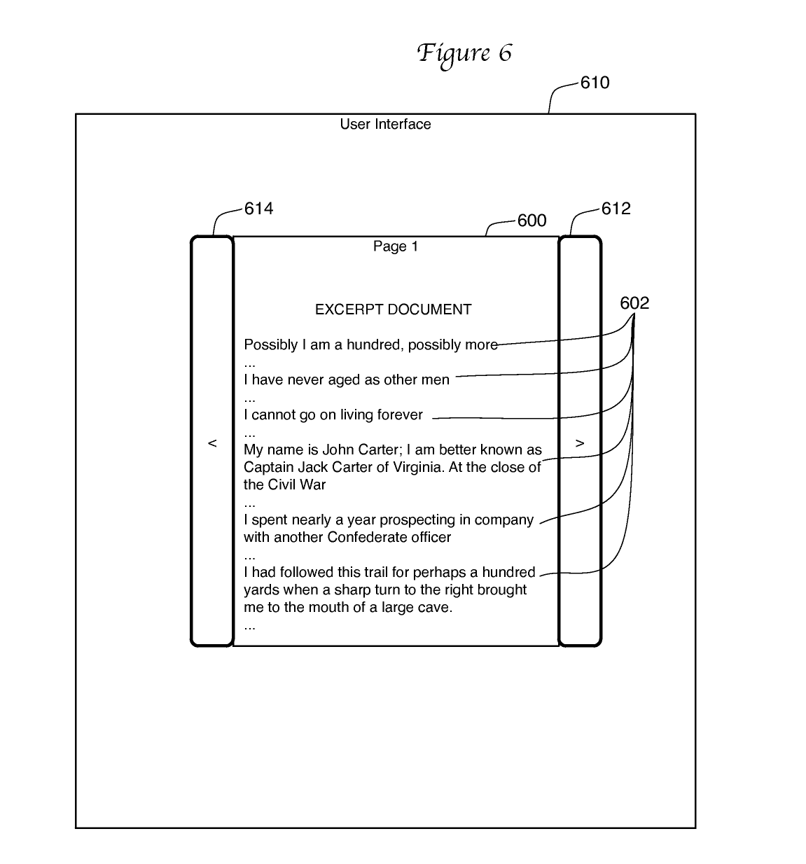

The highlights that are stored in the database entities 350 and 352 can be used to create excerpt documents for a book 310. FIG. 6 shows an excerpt document 600 that is being displayed on an excerpt document interface 610, which is a portion of the user interface 280 displayed on user computer 290. The interface 610 may include a page forward button 612 and page backward button 614 to allow a user to page through a multiple page excerpt document 600. The excerpt document 600 itself is composed of all of the highlighted text portions 602 for a book. The first three highlighted text portions 602 shown in FIG. 6 are the same text portions that were highlighted in FIG. 4. The remaining three highlighted text portions 602 are text portions that came from later pages of the same book. By combining all of the highlighted portions 602 into a single excerpt document 600, a summary document is created that allows a user to quickly review the most important, relevant, or interesting portions of an entire book. The highlighted portions 602 that make up an excerpt document 600 may include only a single type (e.g., color) highlights made by a single user, may include all highlights made by that user, and may include highlights made by third parties for that book.

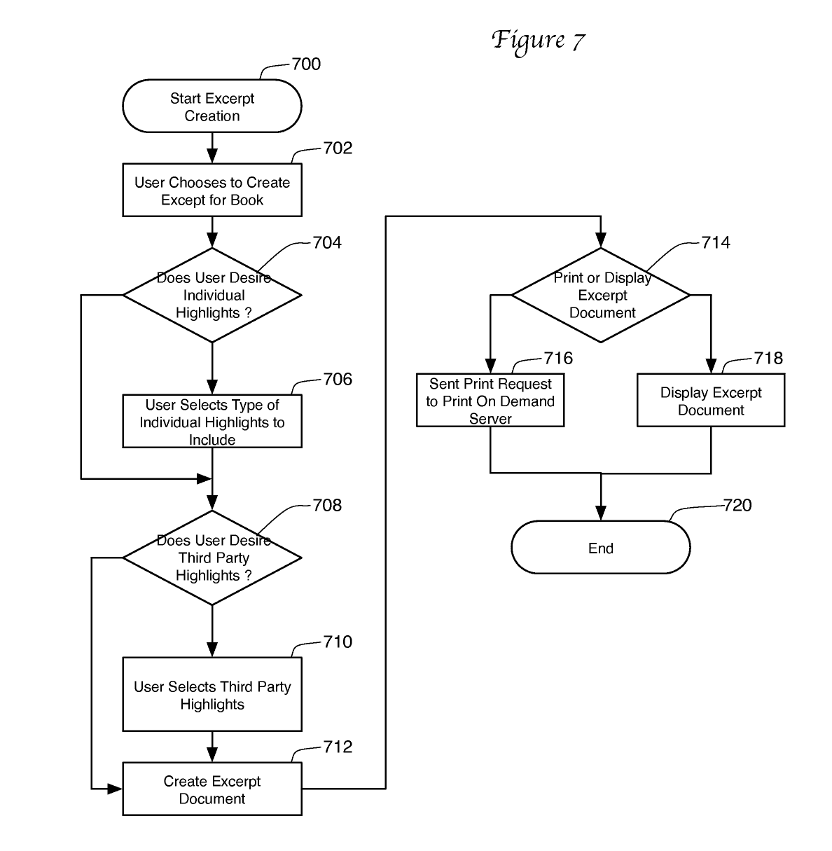

The method 700 for creating an excerpt document is shown in FIG. 7. The method 700 starts at step 702, where a user indicates a desire to create an excerpt document 600. This desire can be through a menu input, or selecting an icon (not shown in Figures) in one of the user interfaces 280 of the computerized system 100. As part of this indication, the user will select the particular book 310 for which they desire an excerpt document. The user is then given the option of including their own highlights of this book in the excerpt document 600. If the user selects this option in step 704, then step 706 allows the user to select the type (color or font format) or types of highlighting that they wish to include in the excerpt document 600. Whether or not the user elects to use their own highlighting, step 708 then determines whether the user wishes to include highlights made by third parties to the book 310. If so, the user must select which highlights to include at step 710. For example, the user could select to include all highlights made by members of one or more groups 360 to which the user belongs. Alternatively, the user may wish to include highlights made by third parties that do not belong to any of their groups 360. For instance, “star highlights” made by highly ranked readers could be selected, or the user could select to include the highlights of just a single, third party reader known to the user. The user may also desire to include only those text portions 602 that have been highlighted by multiple users. In this case, step 710 may request that the user select the minimum number of highlights that a portion must include in order to be included in the excerpt document. This option is useful when the user wishes to control the size of the excerpt document. For example, a popular book may include highlights made by thousands of different users. An excerpt document 600 made of that popular book which required only a single user or two users to highlight a portion before inclusion may itself include nearly as much text as the original book. In one embodiment, the user interface allows the user to vary the minimum number of highlights, and gives immediate feedback to the user as to the size of the resulting excerpt document 600, such as number of excerpts or number of pages in the resulting document.

Once the desired highlights to be included are selected in steps 706 and 710, the excerpt document 600 is created in step 712. This is accomplished by extracting from the database 210 the highlight database elements 352 associated with the desired book that identify the highlighted excerpts 602. In the preferred embodiment, the highlighted excerpts are then sorted so that the excerpts are presented in the same order as the page portions 350 appeared in the book 310. In addition, any highlighted excerpts that overlap are merged together into a single excerpt. In one embodiment, all highlighted excerpts 602 are shown identically in the excerpt document regardless of the type of the original excerpt. In other embodiments, individual highlights are shown differently (e.g., different color or font type) from third party highlights. The user then is given the option in step 714 to either display the excerpt document 600 over the user interface 280 at step 716, or to have the document sent to a print-on-demand server 140 for printing on a physical server 142 at step 718. In other embodiments, the excerpt document 600 is always shown on the user interface 280, and the user is given the option to have the document printed by the print-on-demand server 140. The method 700 then ends at step 720.

### Licensing of Content

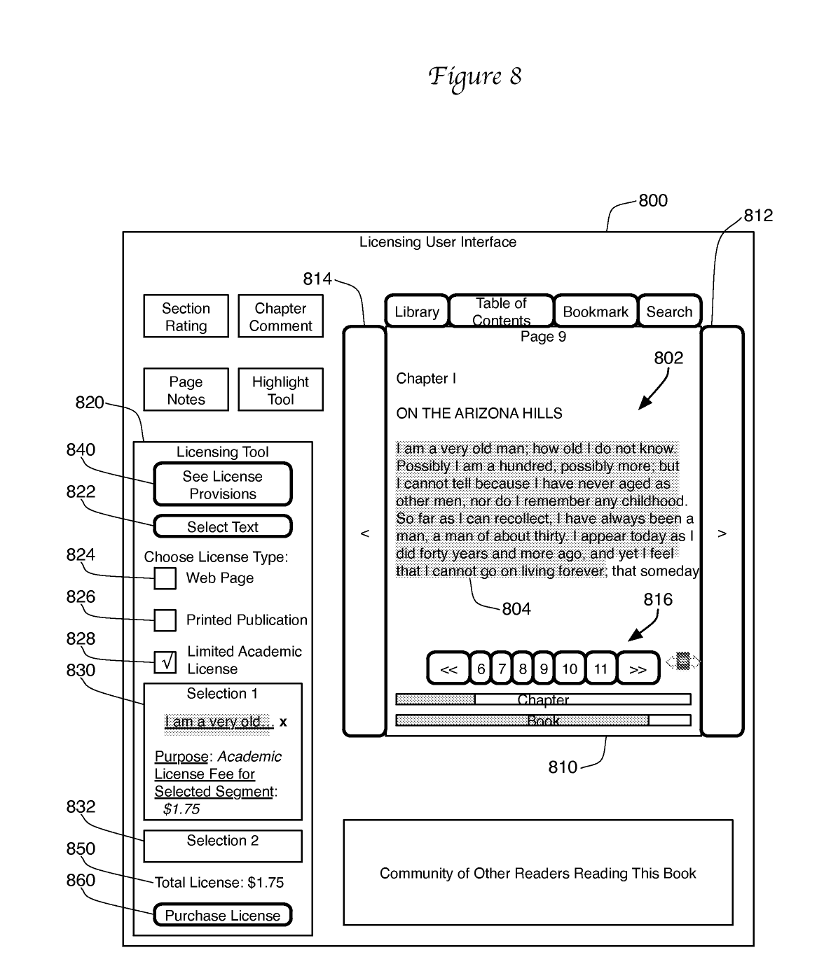

FIG. 8 shows a licensing user interface 800, which can be presented as the user interface 280 to user computer 290. The licensing interface 800 is designed to allow users to license a portion of the text in a book for reuse. This reuse could academic in nature, such as for use in an academic paper or in a classroom environment. Alternatively, the use could be commercial in nature, such as use on a website or use in a brochure, commercial book, or other printed document. The interface presents the text of the book 802 in the same page view 810 used for reading and highlighting a book (as described in connection with FIG. 4). The user can page through the pages of the book use the page forward button 812 and page backward buttons 814 or through the direct page buttons 816. To select the text desired for licensing, the user accesses the licensing tool 820 presented in the licensing user interface 800. The licensing tool 820 provides a “select text” button 822. This allows the user to select a portion 804 of the text 802 shown on the page, which is then identified by adding a background color to the selected text as shown in FIG. 8. As explained above, the system is designed to detect contiguous segments selected on consecutive pages, allowing the system to treat user selections that span multiple pages as a single selection. In one embodiment, the user can select a beginning word on a first page, and an ending word on a later page, and the system will automatically treat all of the content between those words as belonging to a single selection of the user. This could prove useful, for instance, when a user wishes to request a license to use multiple pages, or even an entire chapter, of a book.

When the text portion 804 has been selected, that selection is shown within the licensing tool 820 in selection box 830. Multiple selection boxes 830, 832 can be included in the licensing tool 820 to allow the user to select multiple portions 804 from or many pages 810 in the book. The purpose of selecting the portion 804 is to obtain a legally enforceable license to use that portion 804 in a different context. In one embodiment, the system 100 provides different license terms depending on the use desired by the user. For example, the user of interface 800 can select whether they wish to use the licensed text in the context of a web page, in a printed commercial publication, or for limited academic purposes by selecting checkboxes 824, 826, or 828, respectively. In this embodiment, each license carries a different license rate and different licensing terms. If a user wishes to review the license terms offered under each license, the user selects button 840, which then will present the terms to the user for review.

In FIG. 8, the user has requested a license to use the selected text portion 804 for limited academic purposes, as indicated by box 828. The selection box 830 displays this license purpose along with the first few characters of the selected portion 804. The selection box 830 also indicates that the price for this license is $1.75.

The formula for calculating license fee for a selected text portion 804 takes into account the extent to which the words within the selected portion 804 have been highlighted by other users, as is explained in more detail below in connection with method 900. The price for each portion selected by the user for licensing as indicated in the various selection boxes 830, 832 is summed together to determine a total license price, which is displayed as element 850 in interface 800. Assuming a desire to complete this license transaction for that price 850, the user can complete this license transaction by pressing the purchase license button 860, after which the computer system 100 will receive payment information from the user and deliver the content and license certificate to the user.

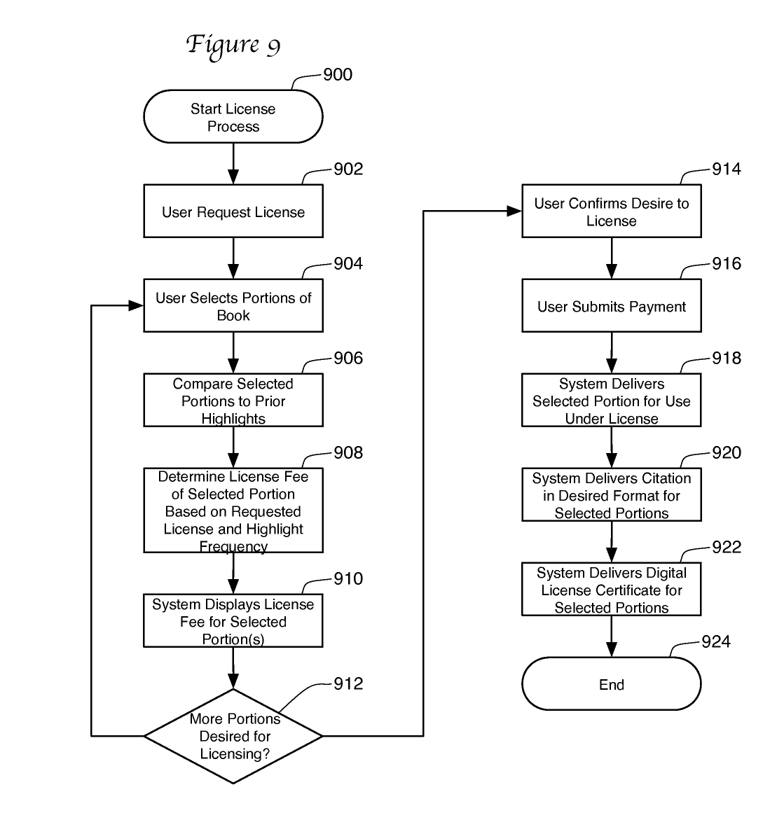

The process 900 for licensing content using interface 800 is shown in FIG. 9. The process 900 starts by a user requesting to start the licensing process for a particular license in step 902. This can be accomplished by selecting the appropriate check box 824-828 for the desired license. At step 904, the user moves the cursor on the screen and selects a portion 804 of the displayed text 802 for licensing. As explained above, this selection may span multiple pages in the book.

To determine the price for the selected portion 804, the system compares the selected words against prior highlights made to this text 802 in step 906. The computer system 100 at step 908 then determines a license fee for the selected portion based on both the selected license (academic versus web page versus printed publication) and the value of the text based on the frequency with which the selected portion has been highlighted. As a hypothetical example, a book may include a total of 200 pages, and contain 40,000 highlights made by a variety of users. Some portions of the book have been highlighted 200 or more times, while other portions may have never been highlighted. The price for licensing text portions from this book will vary depending on the amount of text to be licensed, and the number of times that this text has been highlighted. For example, every ten words in a selected portion that has never been highlighted may be licensed for limited academic use for $0.03. If a portion has been highlighted 1-20 times, the rate may increase to $0.08 per ten words, while the most highlighted portions (200 or more times) may be licensed at a rate of $0.40 per ten words). The rate may be multiples of values for commercial web page or printed publication licenses. These rates may also decrease depending on the number of words. For example, licenses for over 10,000 words may receive a 20% discount.

At step 910, the system 100 displays the license fee for the selected portion 804 within the selection box 830, and updates the total license fee 850 shown in the licensing user interface 800. At step 912, the method 900 allows the user to select additional portions 804 for licensing by going back to step 904. If the user does not wish to select more portions 804, the method 900 waits for confirmation that the user desires to complete the license transaction at step 914. The user can confirm this intent by pressing the purchase license button 860. At step 916, the user will then submit payment for the license according to the calculated total shown at location 850.

Once the license portions have been selected and paid for, the method 900 delivers the licensed content in a usable form in step 918. In the preferred embodiment, it is not possible to copy or otherwise extract the text from the user interfaces 400, 800 for use in other computer programs. Consequently, the license text must be delivered outside these interfaces 400, 800 once the license fee has been paid. This delivery can take place through a new user interface 280 that allows for downloading the licensed content, or the content can be delivered outside the system 100 (such as via e-mail or FTP). In addition to delivering the content, the preferred embodiment also provides in step 920 the licensee of the content a citation for the licensed portions 804 that can be used in academic papers. In the preferred embodiment, the user can request the citation and indentify a preferred citations style, such as the American Psychological Association or APA citation style. The user can then insert both the licensed content and the citation for that content in an appropriate format into their academic paper. Finally, the method delivers to the use a digital license certificate in step 922 that authenticates their license for this content. A variety of certificate technologies exist that can be used for this purpose. The preferred technology will tie the license to the exact content being licensed, the type of licensed involved, and some type of license or licensee identifier. The preferred technology would also render the license certificate tamper resistant, such as through encryption of the certificate with the private encryption key of a licensing authority, such that decryption with the public key could confirm the source of the digital certificate. The process 900 then ends at step 924.

### Highlight Search

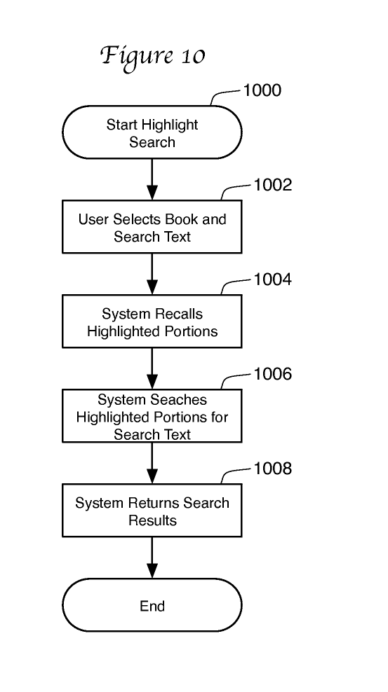

Flowchart 1000 in FIG. 10 sets forth a process to search books using the highlighting capabilities described above. In one embodiment, the user will search for particular text that has been highlighted within a particular document. To perform this search, the user selects the book to be searched and inputs the search text in step 1002. The computer system 100 then recalls all of the text portions 350 that have been highlighted for that book in step 1004, and then compares the search text against those page portions looking for matches in step 1006. If matches are found, the system will provide a list of those highlighted portions of the book that match the search text in step 1008.

Alternatively, the user could request that a search occur over a plurality of books, or over all books 310 in the computer system 100. In these cases, the system would then gather all of the highlighted page portions 350 for those books and search for the text string in those books. The results provided in step 1008 could include a book list specifying which books contain highlights that matched the search text. The user could then select one of the books off of that list, and then be presented with the highlighted portion or portion that matches the search query.

Of course, the system and methods described above are exemplary and are not the exclusive techniques for using the disclosed embodiments. Numerous modifications and variations will readily occur to those skilled in the art. Since such modifications are possible, the invention is not to be limited to the exact construction and operation illustrated and described. Rather, the present invention should be limited only by the following claims.

What is claimed is:

1. A method of creating an excerpt document from a text document comprising:
on a server computer having a processor and tangible, non-transitory computer-readable data storage containing structured data in a computerized database,
a) at the server computer, storing in the database highlight database elements, with each highlight database element identifying
i) a text portion at a location in the text document, and
ii) a user database element associated with a user that has requested the server computer to highlight the portion of the text document;
b) at the server computer, receiving from a request from a first remote computer to create the excerpt document from the text document;
c) at the server computer, extracting from the database a plurality of highlight database elements;
d) at the server computer, identifying a plurality of text portions identified in the plurality of highlight database elements;
e) at the server computer, sorting the plurality of text portions according to their location within the text document; and
f) at the server computer, sending the sorted text portions to the first remote computer as the excerpt document.

2. The method of claim 1, wherein the request identifies a particular user database element, further wherein the server computer extracts from the database only those highlight database elements that identify the particular user database element.

3. The method of claim 1, wherein the request identifies a plurality of user database elements, further wherein the server computer extracts from the database only those highlight database elements that identify one of the identified plurality of user database elements.

4. The method of claim 1, wherein each highlight database element further identifies a highlight format, and further wherein the excerpt document formats the sorted text portions according to the highlight formats specified by the highlight database elements.

5. The method of claim 1, wherein a plurality of highlight database elements in the database relate to the same text portion of the text document, further wherein the request identifies a minimum number of highlight database elements that must relate to the same text portion of the text document before the text portion is included in the excerpt document.

6. The method of claim 1, wherein the database contains highlight database elements that identify text portions of a plurality of text documents.

7. The method of claim 6, wherein the request identifies at least two text documents and the excerpt document contains text portions found in the at least two text documents.

8. The method of claim 1, further comprising:
g) at the server computer, transmitting the sorted text portions to a print-on-demand printer service for printing the excerpt document, and further transmitting delivery information extracted from a user database element associated with the request to the print-on-demand printer service for delivering the printed excerpt document.

9. A method of creating an excerpt document from a text document comprising:
on a server computer having a processor and tangible, non-transitory computer-readable memory containing structured data in a computerized database,
a) at the server computer, transmitting a highlight capable web interface to a user computer, the web interface displaying a displayed page from the text document and a highlight toolbar, the user computer being associated by the server computer with a first user record in the database;
b) at the server computer, receiving a request from the user computer to highlight a text portion of the displayed page, the request identifying the text portion and a highlight format;
c) at the server computer and in response to the request, storing in the database a highlight database element identifying
i) the text portion,
ii) the highlight format, and
iii) the first user record;
d) at the server computer, transmitting instructions to the web interface on the user computer to alter the text portion on the displayed page according to the highlight format; and
e) at the server computer, transmitting instructions to the web interface to add an identifier of the text portion to the highlight toolbar so that the highlight toolbar identifies the text portions highlighted in the displayed page.

10. The method of claim 9, further comprising:
f) at the server computer, receiving a request to display highlights on the displayed page that are associated with a second user record;
g) at the server computer, searching the database for second user highlight database elements identifying text portions on the displayed page and identifying the second user record; and
h) at the server computer, transmitting instructions to the web interface on the user computer to alter the displayed page to identify the text portions identified by the second user highlight database elements.

11. The method of claim 9, wherein each text portion identified in each highlight database element is associated with a single page in the text document.

12. The method of claim 11, further comprising:
f) at the server computer, identifying contiguous highlight database elements by identifying a first highlight database element that identifies a first text portion that extends to the end of a first page, and further identifying a second highlight database element that identifies a second text portion that extends from the beginning of a second page, wherein the first and second pages are contiguous.

13. The method of claim 12, wherein the server computer treats contiguous highlight database elements as a single highlight element.

14. A method of searching text documents comprising:
on a server computer having a processor and tangible, non-transitory computer-readable memory containing structured data in a computerized database,
a) at the server computer, storing in the database highlight database elements, with each highlight database element identifying
i) a text document,
ii) a text portion of the text document, and
iii) a user database element associated with a user that requested the server computer to highlight the text portion of the text document;
b) at the server computer, receiving from a search query containing a search string from a remote computer;
c) at the server computer, identifying relevant highlight database elements by searching the text portions of the text documents identified by the highlight database elements for occurrences of the search string;
d) at the server computer, identifying the text documents identified by the relevant database highlight elements; and
e) at the server computer, transmitting to the remote computer the identities of the identified text documents.

15. The method of claim 14, wherein the identified text documents are sorted according to the number of relevant highlight database elements that identify the identified text documents.

16. A method of valuing text comprising:
on a server computer having a processor and tangible, non-transitory computer-readable memory containing structured data in a computerized database,
a) at the server computer, storing in the database highlight database elements, with each highlight database element identifying
i) a text document,
ii) a text portion of the text document, and
iii) a user database element associated with a user that requested the server computer to highlight the text portion of the text document;
b) at the server computer, identifying a plurality of text elements;
c) at the server computer, counting the number of highlight database elements that identify text portions that are within the each of the plurality of text elements; and
d) at the server computer, assigning each of the text elements a value related to the count from step c).

17. The method of claim 16, wherein the text element is one of a text document, a text chapter, or text page, or a text portion of less than a text page.

18. The method of claim 16, wherein the value assigned to the text element is used to sort the plurality of text elements.

19. The method of claim 16, wherein the value assigned to the text element is used to determine a license fee for obtaining a license to use the text element.

20. A server computer system comprising:
a) at least one processor for processing computer instructions;
b) a network interface for communicating with a first user computer over a network;
c) tangible, non-transitory computer readable memory:
d) structured data residing on the non-transitory memory containing highlight database elements, with each highlight database element identifying a text portion at a location in a text document and a user database element;
e) programming instructions residing on the non-transitory memory, the programming instructions instructing the processor to:
i) receive from a request from the first remote computer to create an excerpt document from the text document,
ii) extract from the database a plurality of highlight database elements for the text document,
iii) identify a plurality of text portions identified in the plurality of highlight database elements,
iv) sort the plurality of text portions according to their location within the text document, and
v) send the sorted text portions to the first remote computer as the excerpt document.
